(19) United States
(12) Patent Application Publication
(10) Pub. No.: US 2023/0141586 A1
(43) Pub. Date: May 11, 2023

(54) THERMALLY INSULATED CARRIER BAG

(71) Applicant: va-Q-tec AG, Würzburg (DE)

(72) Inventors: Kristina Kletzel, Würzburg (DE); Tobias Bock, Kitzingen (DE); Fabian Eschenbach, Rottendorf (DE); Joachim Kuhn, Würzburg (DE)

(21) Appl. No.: 17/984,909

(22) Filed: Nov. 10, 2022

(30) Foreign Application Priority Data
Nov. 11, 2021 (DE) 202021106156.1

(51) Int. Cl. A47J 47/14; B65D 81/38

(52) U.S. Cl. CPC A47J 47/14; B65D 81/38; B65D 2313/02

(57) ABSTRACT

Thermally insulated carrier bag to be carried by one person, comprising an insulation cover with a base insulation element, a peripheral insulation side wall (and a cover insulation element, which are designed in such a way as to form a receiving space. Enclosing, further comprising a carrying case with a base element, a peripheral side wall and a cover element, which are designed in such a way as to enclose an interior space for the insulation case, the base insulation element and/or the insulating side wall and/or the lid insulating element comprise at least one vacuum insulating element, and the carrying case has at least one carrying element for carrying by one person.

### CROSS-REFERENCE TO RELATED APPLICATIONS

This patent application claims priority to German utility patent application number 20 2021 106 156.1 filed Nov. 11, 2021 and titled “thermally insulated carrier bag”. The subject matter of patent application number 20 2021 106 156.1 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention pertains to a thermally insulated carrier bag to be carried by a person according to the independent claim.

### BACKGROUND

Thermally insulated carrier bags pertain to the technical field of thermally insulated containers for temperature-controlled transport. They serve the purpose of transporting temperature-sensitive transport goods, such as foodstuffs or beverages for example in summer, in a cooled environment.

In particular, thermally insulated containers in the form of transport boxes are known. Such thermally insulated transport boxes are usually designed to allow easy loading and stowing for transport at elevated temperatures outdoors.

In this context, the thermally insulated transport boxes are formed, for example, from a molded foam part, which is formed into a desired shape by foaming of a foaming material in a molding tool. Such thermally insulated transport boxes are advantageously insulated with vacuum insulation panels, which provide particularly efficient insulation. However, such transport boxes have the disadvantage that they are not well suited for being carried by a person.

### SUMMARY

The invention pertains to provide a thermally insulated carrier bag which overcomes the disadvantages of the prior art by ensuring good insulation and being suitable for being carried by a person.

This object is attained by the thermally insulated carrier bag according to the independent claim. Advantageous embodiments form the subject-matter of the respective subclaims.

The invention encompasses a thermally insulated carrier bag to be carried by a person, comprising an insulating casing having a bottom insulating element, a circumferential insulating side wall and a cover insulating element, which are designed to enclose an interior space, and further comprising a carrier casing having a bottom element, a circumferential side wall and a cover element, which are designed to enclose the interior space and the insulating casing, wherein the bottom insulating element and/or the insulating side wall and/or the cover insulating element comprise at least one vacuum insulation element (vacuum insulation panel—VIP), and wherein the carrier casing comprises at least one carrier element to enable carrying by a person. The carrier casing is made of a flexible robust fabric, plastic or metal material to provide a robust and wear-resistant outer surface. The carrier element can be a handle or a pair of shoulder straps. In this way, elegant thermally insulated carrier bags can be realized, which have a particularly slim design appearance due to the vacuum insulation panels used.

### BRIEF DESCRIPTION OF THE DRAWINGS

In the following, the invention will be explained in greater detail with reference to drawings, wherein:

FIG. 1 is a perspective view of a thermally insulated carrier bag as a backpack according to an exemplary embodiment of the invention;

FIG. 2 is a side sectional view of the backpack of FIG. 1; and

FIG. 3 is a perspective view of the insulating casing for the carrier bag of FIG. 1.

### DETAILED DESCRIPTION

According to an advantageous aspect, the vacuum insulation element comprises a vacuum insulation panel, which in each case has a thermal conductivity coefficient λ in a range between 1 mW/mK and 200 mW/mK. The vacuum insulation panel has the advantage of achieving a particularly simple design due to its inherent rigidity.

Preferably, the carrier casing has at least one first carrier element arranged on the cover element and at least one second carrier element arranged on the side wall. Advantageously, the carrier element may be a handle centrally disposed on the cover element or two shoulder straps each having one end attached to the cover element.

According to a preferred aspect, the cover element is arranged on the side wall with a releasable closure in such a way that releasing the closure and moving the cover element results in exposure of an opening into the interior space. This closure may be a zipper.

Preferably, the bottom insulating element is connected to the bottom element, the insulating side wall is connected to the side wall, and the cover insulating element is connected to the cover element in each case in a releasable or non-releasable manner The releasable connection can be realized by means of insertion into a corresponding pocket-shaped recess. In the case of a non-releasable connection, an adhesive may be applied between the elements.

Further preferably, the bottom insulating element is connected to the bottom element, the insulating side wall is connected to the side wall, and the cover insulating element is connected to the cover element in each case releasably by means of a hook-and-loop fastener. In this way, the elements can be fixed in their position relative to each other.

Advantageously, the insulating casing is designed to be dimensionally stable. The inherent rigidity of a vacuum insulation panel is suitable for creating the dimensional stability of the insulating casing.

Particularly preferably, the bottom insulating element and/or the cover insulating element is/are releasably connected to the insulating side wall.

According to another aspect, the bottom insulating element and/or the cover insulating element is/are releasably connected to the insulating side wall by a hook-and-loop-fastener.

Advantageously, the bottom insulating element and/or the insulating side wall and/or the cover insulating element each comprises/comprise a protective layer.

Preferably, the carrier bag is a backpack or a bicycle bag.

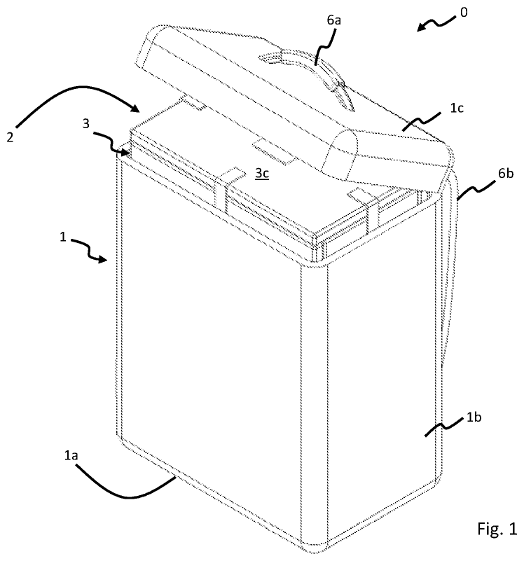

In FIG. 1, a thermally insulated carrier bag 0 to be carried by a person according to an exemplary embodiment of the invention is shown.

In the interior, the upper part of an insulating casing 3 can be seen, which, in the shown closed state, encloses a receiving space for receiving the goods to be carried, wherein a partial section of the cover insulating element 3c can be seen from the insulating casing 3 with the upper side.

The inner-lying insulating casing 3, which is partially visible in the illustration shown, is enclosed by a carrier casing 1. The carrier casing 1 comprises a rectangular bottom element 1a on its lower side. A completely circumferential side wall 1b extends upwards from the bottom element 1a and internally forms an interior space with a rectangular layout having such a shape and dimension that the insulating casing 3 is enclosed in a flush manner. The overlying cover element 1c has a lateral circumferential closure to be connected to the side wall 1b to enclose the interior space 2 and the insulating casing 3.

The cover element 1c is arranged on the side wall 1b to be closable with a zipper, wherein an opening 4 to the interior space 2 is exposed in response to releasing the closure and moving the cover element 1c.

In this example, the bottom insulating element 3a and the insulating side wall 3b and the cover insulating element 3c have exactly one vacuum insulation element.

In the illustrated backpack, the carrier casing 1 has three carrier elements 6a, 6b in the form of a carry handle 6a and two shoulder straps 6b to enable carrying by a person.

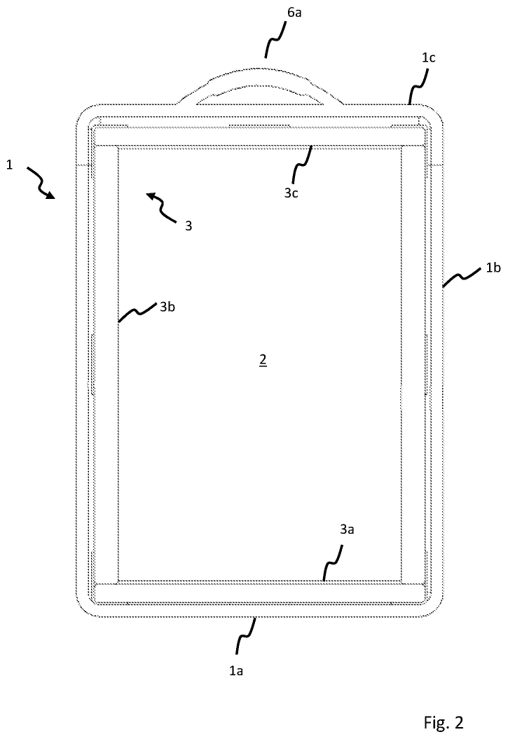

FIG. 2 shows the side sectional view of the backpack. The insulating casing is formed with an underlying bottom insulating element 3a, a laterally circumferential insulating side wall 3b and an overlying cover insulating element 3c, which enclose a receiving space 2 for the goods to be transported.

In this regard, the bottom insulating element 3a is connected to the bottom element 1a, the insulating side wall 3b is connected to the side wall 1b and the cover insulating element 3c is connected to the cover element 1c in each case releasably by means of Velcro.

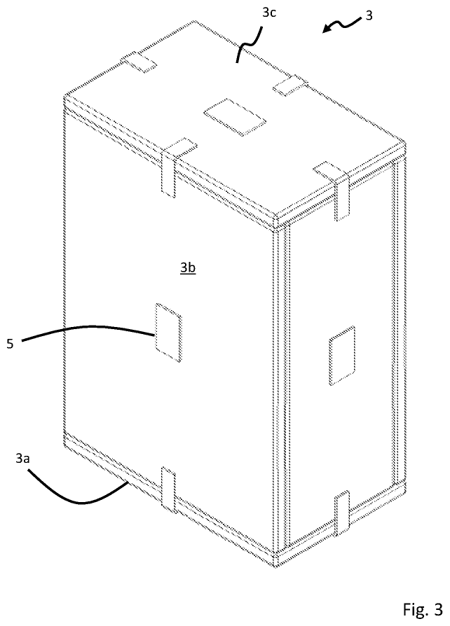

FIG. 3 shows a perspective view of the removed insulating casing for the backpack from FIG. 1. The insulating casing 3 is formed to be dimensionally stable in that the vacuum insulation elements in each case are vacuum insulation panels. The vacuum insulation panels each have a thermal conductivity coefficient λ in a range between 1 mW/mK and 200 mW/mK.

The bottom insulating element 3a and/or the insulating side wall 3b and/or the cover insulating element 3c each have a protective layer 5 in the form of a square robust piece of fabric.

What is claimed is:

1. Thermally insulated carrier bag to be carried by a person, comprising:
an insulating casing having a bottom insulating element, a circumferential insulating side wall and a cover insulating element, which are designed to enclose a receiving space, further comprising:
a carrier casing comprising a bottom element, a circumferential side wall and a cover element, which are designed to enclose an interior space for the insulating casing, wherein
the bottom insulating element and/or the insulating side wall and/or the cover insulating element comprises/comprise at least one vacuum insulation element, and wherein the carrier casing has at least one carrier element to enable carrying by a person.

2. Thermally insulated carrier bag according to claim 1, wherein the vacuum insulation element comprises a vacuum insulation panel, which in each case has a thermal conductivity coefficient λ in a range between 1 mW/mK and 200 mW/mK.

3. Thermally insulated carrier bag according to claim 1, wherein the carrier casing comprises at least one first carrier element arranged on the cover element and at least one second carrier element arranged on the side wall.

4. Thermally insulated carrier bag according to claim 1, wherein the cover element is arranged on the side wall with a releasable closure in such a way that in response to releasing the closure and moving the cover element an opening to the interior space is exposed.

5. Thermally insulated carrier bag according to claim 1, wherein the bottom insulating element is connected to the bottom element, the insulating side wall is connected to the side wall, and the cover insulating element is connected to the cover element, in each case in a releasable or non-releasable manner

6. Thermally insulated carrier bag according to claim 5, wherein the bottom insulating element is connected to the bottom element, the insulating side wall is connected to the side wall and the cover insulating element is connected to the cover element, in each case releasably by means of a hook-and-loop fastener.

7. Thermally insulated carrier bag according to claim 1, wherein the insulating casing is designed to be dimensionally stable.

8. Thermally insulated carrier bag according to claim 1, wherein the carrier casing is designed to be dimensionally stable or deformable.

9. Thermally insulated carrier bag according to claim 1, wherein the bottom insulating element and/or the cover insulating element is/are releasably connected to the insulating side wall.

10. Thermally insulated carrier bag according to claim 9, wherein the bottom insulating element and/or the cover insulating element is/are releasably connected to the insulating side wall by means of a hook-and-loop fastener.

11. Thermally insulated carrier bag according to claim 1, wherein the bottom insulating element and/or the insulating side wall and/or the cover insulating element each has/have a protective layer.

12. Thermally insulated carrier bag according to claim 1, wherein the carrier bag is a backpack or a bicycle bag.
